(19) United States
(12) Patent Application Publication
(10) Pub. No.: US 2017/0259868 A1
(43) Pub. Date: Sep. 14, 2017

(54) Bell Cover Lighting Structure

(71) Applicant: YUAN WEN SHING INDUSTRIES CORP., Chang-Hua (TW)

(72) Inventor: CHING-HUANG HU, Chang-Hua (TW)

(21) Appl. No.: 15/220,364

(22) Filed: Jul. 26, 2016

(30) Foreign Application Priority Data
Mar. 11, 2016 (TW) 105203365

(51) Int. Cl. B62J 6/02

(52) U.S. Cl. CPC B62J 6/02

(57) ABSTRACT

A bell cover lighting structure includes a fixing seat; a connecting seat disposed on the connecting seat; a bell cover mount at a front side of the connecting seat and having a concave space defined by an inner circumferential surface thereof; a lighting device accommodated in the concave space of the bell cover; and a striking member. The striking member has a push section at one end thereof and an extension section bent and extending over the bell cover at another end thereof. The striking member is provided with an elastic member pivotally connected with the striking member and the connecting seat. One end of the elastic member leans against a lower edge of the push section and another end leans against the connecting seat, enabling the extension section to have elasticity for striking the bell cover.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a bell cover lighting structure, and more particularly to a bike bell that combines a lighting device with a bell cover.

Description of Related Arts

Due to the rising fuel price and the growing level of environmental consciousness, many people ride a bike as a means of transportation. This not only reduces exhaust gas from cars or motorbikes but also achieves fitness and exercise effects. Thus, riding a bike becomes a trend. However, when the weather is not good or it is too dim, the rider will turn on a lighting device provided on the bike for illumination and warning. In order to ensure the safety of riding at night, it is necessary to install a lighting device on a bike if the bike doesn't have a lighting configuration. In general, the lighting device is designed to be integral with a bike bell so as to simplify the assembly of the bike handlebar accessories and to increase the convenience of control. As shown in FIG. 1, a conventional bike bell 10 having a lighting device comprises a bell cover 11 mounted on a base 12. One side of the base 12 is provided with an elastic striking end 13. The top of the striking end 13 has a striking hammer 131. The bottom of the base 12 is provided with a first connecting assembly 14 connected with a first C-shaped fastening ring 15 for locking the bike bell 10 on a bike handlebar 16. The bottom of the first C-shaped fastening ring 15 is provided with a second connecting assembly 17 connected with a second C-shaped fastening ring 18 for retaining a lighting device 19 to provide illumination and warning functions. However, this structure has some problems as follows.

1. The lighting device 19 is additionally disposed outside the bike bell 10. As a result, the entire size of the bike bell 10 is increased. It is easy to collide with other articles and inconvenient for use.

2. The second connecting assembly 17 and the second C-shaped fastening ring 18 are provided for retaining the lighting device 19, which increases the manufacture cost of the bike bell and is quite troublesome and time-consuming for assembly. Therefore, this structure is not practical.

Accordingly, the inventor of the present invention has devoted himself based on his many years of practical experiences to solve these problems.

### SUMMARY OF THE PRESENT INVENTION

The primary object of the present invention is to solve the above-mentioned problems and provide a bell cover lighting structure. The main technology of the present invention is that a bell cover is formed with a concave space therein for accommodating a lighting device. The outer circumferential surface of the lighting device is not in contact with the inner circumferential surface of the bell cover to ensure that the sound quality of the bike bell won't be influenced. The size of the bike bell is reduced, so it can be assembled more conveniently.

In order to achieve the aforesaid object, the bell cover lighting structure of the present invention includes a fixing seat, a connecting seat, a bell cover, a lighting device, and a striking member. The fixing seat has a through hole penetrating upper and lower ends thereof. One side of the fixing seat is provided with a fastening strip. The connecting seat has a first connecting hole at a bottom thereof, a second connecting hole at a front side thereof, and a pivot hole at a side thereof. The connecting seat is disposed on the fixing seat. The fixing seat and the connecting seat are riveted with a first rivet member passing through the through hole and the first connecting hole. The bell cover is mounted at the front side of the connecting seat. The bell cover is formed with a central perforation. The bell cover has a concave space defined by an inner circumferential surface thereof. The bell cover is riveted to the connecting seat with a second rivet member passing through the perforation and the second connecting hole. The second rivet member has a central mounting hole. The lighting device is provided with a mounting rod at a central portion of a rear end thereof. The lighting device is accommodated in the concave space of the bell cover. The striking member is pivotally connected with the pivot hole of the connecting seat. The striking member has a push section at one end thereof and an extension section bent and extending over the bell cover at another end thereof. The striking member is provided with an elastic member, enabling the extension section to have elasticity for striking the bell cover.

In an embodiment of the present invention, the striking member has a pivot seat between the push section and the extension section, and the striking member is riveted to the connecting seat with a third rivet member passing through the pivot seat and the pivot hole.

In an embodiment of the present invention, the elastic member is pivotally connected to the pivot seat through the third rivet member.

In an embodiment of the present invention, the connecting seat is provided with a limit piece for blocking a lower edge of the extension section. The elastic member is an L-shaped torsion spring. One end of the torsion spring leans against a lower edge of the push section, and another end of the torsion spring leans against a lower edge of the limit piece.

In an embodiment of the present invention, a gap H is defined between an outer circumferential surface of the lighting surface and the inner circumferential surface of the bell cover.

In an embodiment of the present invention, another side of the fixing seat is provided with a hook member to buckle the fastening strip.

In an embodiment of the present invention, the bell cover is formed with a plurality of apertures around the perforation.

In an embodiment of the present invention, the mounting rod has outer threads thereon. The mounting hole has inner threads therein. The mounting rod is screwedly connected to the mounting hole.

In an embodiment of the present invention, the bell cover has an opening facing forward.

Through the foregoing structure, the lighting device is accommodated in the bell cover to reduce the size of the bike bell. The present invention can be used conveniently, and the cost is lowered.

### BRIEF DESCRIPTION OF THE DRAWINGS

FIG. 1 is a perspective view of a conventional bike bell and a lighting device coupled on a bike handlebar;

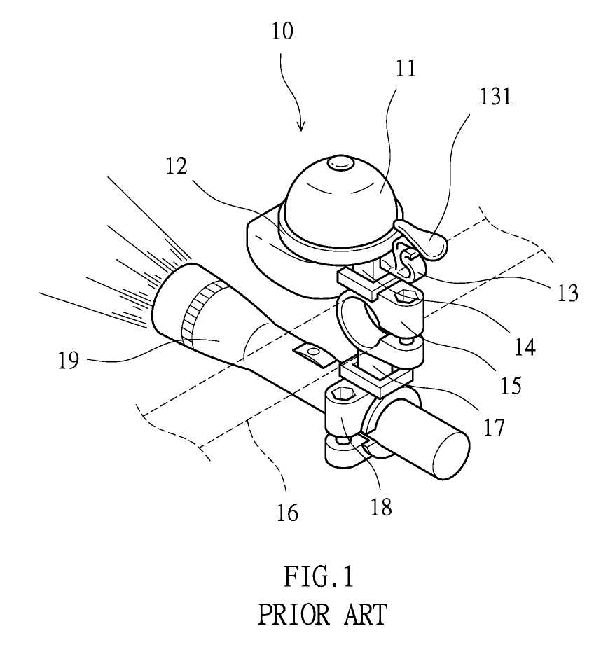

FIG. 2 is an exploded view in accordance with a preferable embodiment of the present invention;

FIG. 3 is a perspective view in accordance with the preferable embodiment of the present invention coupled on a bike handlebar; and

FIG. 4 is a sectional view in accordance with the preferable embodiment of the present invention.

### DETAILED DESCRIPTION OF THE PREFERRED EMBODIMENT

Embodiments of the present invention will now be described, by way of example only, with reference to the accompanying drawings.

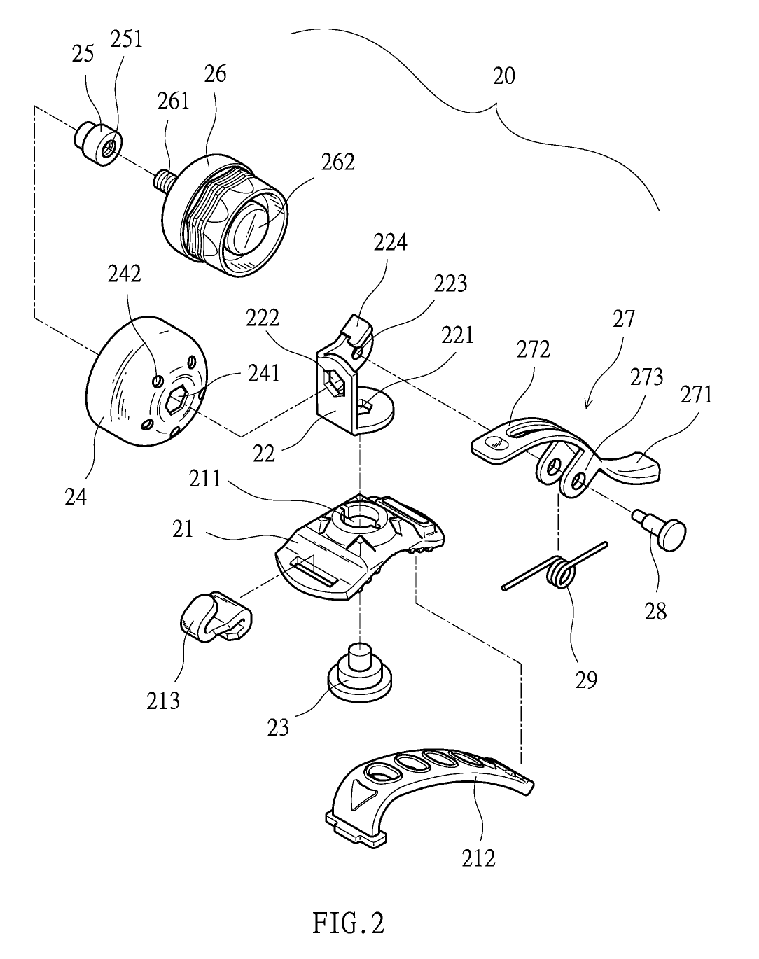

Referring to FIG. 2 to FIG. 4, the present invention discloses a bell cover lighting structure. The bell cover lighting structure includes a fixing seat 21, a connecting seat 22, a bell cover 24, a lighting device 26, and a striking member 27.

The fixing seat 21 has a through hole 211 penetrating upper and lower ends thereof. One side of the fixing seat 21 is provided with a fastening strip 212. Another side of the fixing seat 21 is provided with a hook member 213 to buckle the fastening strip 212.

The connecting seat 22 is formed with a first connecting hole 221 at a bottom thereof, a second connecting hole 222 at a front side thereof, and a pivot hole 223 at a side thereof. The connecting seat 22 is disposed on the fixing seat 21. The fixing seat 21 and the connecting seat 22 are riveted with a first rivet member 23 passing through the through hole 211 and the first connecting hole 221.

The bell cover 24 is mounted at the front side of the connecting seat 22. The bell cover 24 is formed with a central perforation 241 and a plurality of apertures 242 around the perforation 241. The bell cover 24 has a concave space 243 defined by an inner circumferential surface thereof. The bell cover 24 is riveted to the connecting seat 22 with a second rivet member 25 passing through the perforation 241 and the second connecting hole 222. The second rivet member 25 has a central mounting hole 251.

The lighting device 26 is provided with a mounting rod 261 at the center of a rear end thereof. The mounting rod 261 having outer threads thereon is screwedly connected to the mounting hole 251 having inner threads therein, such that the lighting device 26 is accommodated in the concave space 243 of the bell cover 24 and a gap H is defined between an outer circumferential surface of the lighting surface 26 and the inner circumferential surface of the bell cover 24.

The striking member 27 has a push section 271 at one end thereof, an extension section 272 bent and extending over the bell cover 24 at another end thereof, and a pivot seat 273 between the push section 271 and the extension section 272. The striking member 27 is riveted to the connecting seat 22 with a third rivet member 28 passing through the pivot seat 273 and the pivot hole 223. The striking member 27 is provided with an elastic member 29. The elastic member 29 is pivotally connected to the pivot seat 273 through the third rivet member 28. The connecting seat 22 is provided with a limit piece 224 for blocking a lower edge of the extension section 272. The elastic member 29 is an L-shaped torsion spring. One end of the torsion spring leans against a lower edge of the push section 271, and another end of the torsion spring leans against a lower edge of the limit piece 224, enabling the extension section 272 to have elasticity for striking the bell cover 24. Through the aforesaid structure, the bell cover 24 is able to accommodate the lighting device 26 so as to reduce the size of a bike bell 20. The present invention is more convenient for use.

The assembly, function and details of the foregoing embodiment are explained below. Referring to FIG. 2 to FIG. 4, to assemble the bike bell 20 of the present invention, the first rivet member 23 is first inserted through the through hole 211 from the bottom of the fixing member 21 and the first connecting hole 221 of the connecting seat 22, and the first rivet member 23 is compressed and deformed by a riveting machine for a rivet joint, such that the connecting seat 22 is coupled to the fixing seat 21. Because they are connected by riveting, when a larger force is applied to the connecting seat 22, the connecting seat 22 can be turned. Afterward, the second rivet member 25 is inserted through the perforation 241 of the bell cover 24 and the second connecting hole 222 of the connecting seat 22, and the second rivet member 25 is compressed and deformed by a riveting machine for a rivet joint, such that the bell cover 24 is coupled to the connecting seat 22. The bell cover 24 has an opening facing forward. The mounting rod 261 of the lighting device 26 is screwed to the mounting hole 251 of the second rivet member 25 from the concave space 243 of the bell cover 24 so that the lighting device 26 is accommodated in the bell cover 24 like a lampshade and illuminates forward. It is noted that the outer circumferential surface of the lighting device 26 is not in contact with the inner circumferential surface of the bell cover 24. That is, the gap H is defined between the lighting device 26 and the bell cover 24, such that the sound quality of the vibration of the bell cover 24 won't be influenced after struck. Finally, the third rivet member 28 is inserted through the pivot seat 273 of the striking member 27, the elastic member 29, and the pivot hole 223, and the third rivet member 28 is compressed and deformed by a riveting machine for a rivet joint, such that the striking member 27 is coupled to the connecting seat 22 in a seesaw manner. The elastic member 29 is located under the push section 271 to apply torsion for the extension section 272 to have elasticity towards the bell cover 24. In order to ensure that the sound quality of the vibration of the bell cover 24 won't be influenced after struck by the extension section 272 of the striking member 27, the limit piece 224 is to block the lower edge of the extension section 272 so that the extension section 272 is spaced a slight distance apart from the bell cover 24 and won't get contact with the bell cover 24. Through the foregoing structure, the lighting device 26 is accommodated in the concave space 243 of the bell cover 24. There is no need to provide additional fittings for assembling the lighting device so that the size of the bike bell 20 can be reduced. The present invention can be used conveniently, and the cost is lowered.

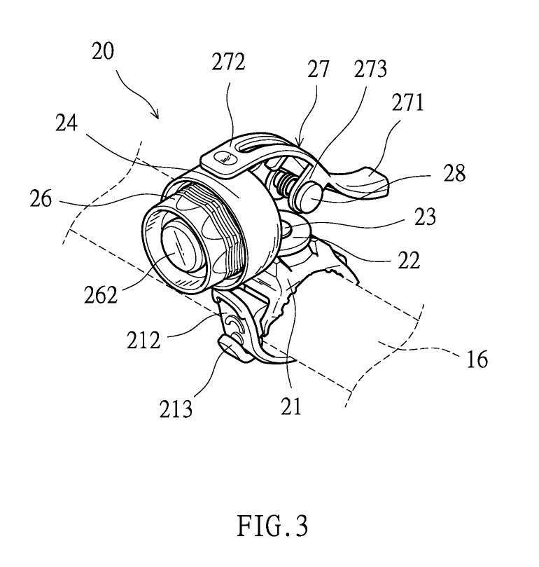

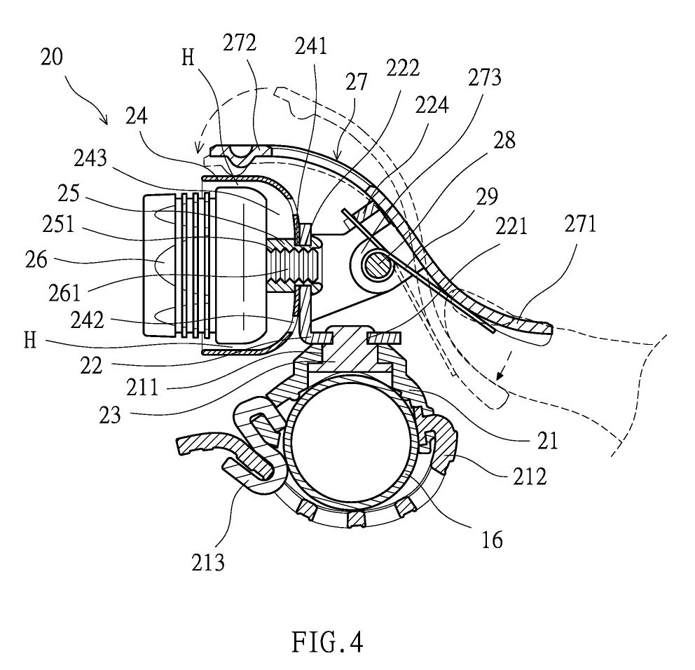

As shown in FIG. 3 and FIG. 4, when in use, the fastening strip 212 is wound on a bike handlebar 16, and the up and down illuminating angle of the lighting device 26 can be adjusted, and the hook member 213 is to hook and buckle the fastening strip 212. The connecting seat 22 can be turned with the first rivet member 23 as the axle to adjust the left and right illuminating angle of the lighting device 26. In a preferable embodiment, the lighting device 26 is provided with a light cap 262 which also functions as a press switch to turn on/off the lighting device 26. When the user wants to ring the bell, the push section 271 of the striking member 27 is pressed with his/her finger to react against the torsion of the elastic member 29. After released (as shown by the broken line of FIG. 4), the striking member 27 is biased by the elastic member 29 to be restored and the extension section 272 of the striking member 27 is to strike the bell cover 24. Although the extension section 272 is blocked by the limit piece 224, the striking member 27 is made of a metallic material to possess elastic deformation capability. Thus, the extension section 272 can be elastically deformed to strike the bell cover 24 to ring the bike bell 20.

Referring to FIG. 4, it is noted that when the rider rides the bike on a rainy day, the rain in the concave space 243 of the bell cover 24 can be drained through the apertures 242 near the perforation 241 to prevent the gap H from being filled up with the rain to influence the sound of the bike bell 20. Another function of the apertures 242 is to bring convection for the air in the bell cover 24 during riding, avoiding resistance and dust accumulated.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A bell cover lighting structure, comprising:
a fixing seat having a through hole penetrating upper and lower ends thereof, one side of the fixing seat being provided with a fastening strip;
a connecting seat having a first connecting hole at a bottom thereof, a second connecting hole at a front side thereof, and a pivot hole at a side thereof, the connecting seat being disposed on the fixing seat, the fixing seat and the connecting seat being riveted with a first rivet member passing through the through hole and the first connecting hole;
a bell cover mounted at the front side of the connecting seat, the bell cover being formed with a central perforation, the bell cover having a concave space defined by an inner circumferential surface thereof, the bell cover being riveted to the connecting seat with a second rivet member passing through the perforation and the second connecting hole, the second rivet member having a central mounting hole;
a lighting device provided with a mounting rod at a central portion of a rear end thereof, the lighting device being accommodated in the concave space of the bell cover; and
a striking member pivotally connected with the pivot hole of the connecting seat, the striking member having a push section at one end thereof and an extension section bent and extending over the bell cover at another end thereof, the striking member being provided with an elastic member, enabling the extension section to have elasticity for striking the bell cover.

2. The bell cover lighting structure as claimed in claim 1, wherein the striking member has a pivot seat between the push section and the extension section, and the striking member is riveted to the connecting seat with a third rivet member passing through the pivot seat and the pivot hole.

3. The bell cover lighting structure as claimed in claim 2, wherein the elastic member is pivotally connected to the pivot seat through the third rivet member.

4. The bell cover lighting structure as claimed in claim 1, wherein the connecting seat is provided with a limit piece for blocking a lower edge of the extension section, the elastic member is an L-shaped torsion spring, one end of the torsion spring leans against a lower edge of the push section, and another end of the torsion spring leans against a lower edge of the limit piece.

5. The bell cover lighting structure as claimed in claim 2, wherein the connecting seat is provided with a limit piece for blocking a lower edge of the extension section, the elastic member is an L-shaped torsion spring, one end of the torsion spring leans against a lower edge of the push section, and another end of the torsion spring leans against a lower edge of the limit piece.

6. The bell cover lighting structure as claimed in claim 3, wherein the connecting seat is provided with a limit piece for blocking a lower edge of the extension section, the elastic member is an L-shaped torsion spring, one end of the torsion spring leans against a lower edge of the push section, and another end of the torsion spring leans against a lower edge of the limit piece.

7. The bell cover lighting structure as claimed in claim 1, wherein a gap H is defined between an outer circumferential surface of the lighting surface and the inner circumferential surface of the bell cover.

8. The bell cover lighting structure as claimed in claim 1, wherein another side of the fixing seat is provided with a hook member to buckle the fastening strip.

9. The bell cover lighting structure as claimed in claim 1, wherein the bell cover is formed with a plurality of apertures around the perforation.

10. The bell cover lighting structure as claimed in claim 1, wherein the mounting rod has outer threads thereon, the mounting hole has inner threads therein, and the mounting rod is screwedly connected to the mounting hole.
